(19) United States
(12) Patent Application Publication
(10) Pub. No.: US 2013/0343299 A1
(43) Pub. Date: Dec. 26, 2013

(54) METHOD FOR CQI FEEDBACK WITHOUT SPATIAL FEEDBACK (PMI/RI) FOR TDD COORDINATED MULTI-POINT AND CARRIER AGGREGATION SCENARIOS

(71) Applicant: Samsung Electronics Co., LTD, Suwon-si (KR)

(72) Inventors: Krishna Sayana, San Jose, CA (US); Young-Han Nam, Richardson, TX (US)

(21) Appl. No.: 13/923,015

(22) Filed: Jun. 20, 2013

Related U.S. Application Data
(60) Provisional application No. 61/662,661, filed on Jun. 21, 2012.

(51) Int. Cl. H04B 7/04

(52) U.S. Cl. CPC H04B 7/0417
USPC 370/329; 370/328

(57) ABSTRACT

Methods and apparatus of a base station (BS) communicating with a user equipment (UE) are provided. The BS transmits N channel state information reference signal (CSI-RS) on N CSI-RS antenna ports, which is received by the UE. A transmission mode is configured that supports coordinated multi-point (COMP) transmissions. A channel quality information (CQI) feedback configuration requires CQI feedback without a precoding matrix index (PMI) and without a rank indicator (RI). The BS receives a CQI transmitted by the UE, which is in accordance with the CQI feedback configuration. If N is one, the CQI is calculated on a single antenna port, antenna port 7, and the single antenna port is mapped from the N equals one CSI-RS antenna port.

### CROSS-REFERENCE TO RELATED APPLICATION(S) AND CLAIM OF PRIORITY

The present application claims priority to U.S. Provisional Patent Application Ser. No. 61/662,661, filed Jun. 21, 2012, entitled “METHOD FOR CQI FEEDBACK WITHOUT SPATIAL FEEDBACK (PMI/RI) FOR TDD COORDINATED MULTI-POINT AND CARRIER AGGREGATION SCENARIOS”. The content of the above-identified patent document is incorporated herein by reference.

### TECHNICAL FIELD

The present application relates generally to multiple input multiple output systems and, more specifically, to time division duplexing multiple input multiple output systems.

### BACKGROUND

Channel quality feedback and spatial feedback are key components of a closed loop multiple input multiple output (MIMO) communication system to obtain gains from beamforming, spatial multiplexing and multi-user transmissions. In time division duplexing (TDD) systems, the downlink precoding can be determined by the transmitter by measuring the uplink channel, exploiting channel reciprocity in TDD.

Alternatively, in frequency division duplexing (FDD) systems, the transmitter/evolved Node B (eNB) must rely on the receiver/user equipment (UE) to receive the spatial feedback. In FDD, a channel quality metric is fed back to the eNB along with an associated precoding matrix indicator (PMI).

### SUMMARY

A method of operating a base station (BS) communicating with a user equipment (UE) are provided. The BS transmits N channel state information reference signal (CSI-RS) on N CSI-RS antenna ports to the UE. A transmission mode is configured that supports coordinated multi-point (COMP) transmissions. A channel quality information (CQI) feedback configuration requires CQI feedback without a precoding matrix index (PMI) and without a rank indicator (RI). The BS receives a CQI from the UE according to the CQI feedback configuration. If N is one, the CQI is calculated on a single antenna port, antenna port 7, and the single antenna port is mapped from the N equals one CSI-RS antenna port.

A base station (BS) communicating with a user equipment (UE) is provided. The BS comprises a transmit path configured to transmit N channel state information reference signal (CSI-RS) on N CSI-RS antenna ports to the UE. A transmission mode is configured that supports coordinated multi-point (COMP) transmissions. A channel quality information (CQI) feedback configuration requires CQI feedback without a precoding matrix index (PMI) and without a rank indicator (RI). The BS comprises processing circuitry configured to receive a CQI from the UE according to the CQI feedback configuration. If N is one, the CQI is calculated on a single antenna port, antenna port 7, and the single antenna port is mapped from the N equals one CSI-RS antenna port.

A method of operating a user equipment (UE) communicating with a base station (BS) is provided. The UE receives N channel state information reference signal (CSI-RS) on N CSI-RS antenna ports from the BS. A transmission mode is configured that supports coordinated multi-point (COMP) transmissions. A channel quality information (CQI) feedback configuration requires CQI feedback without a precoding matrix index (PMI) and without a rank indicator (RI). The UE transmits a CQI to the BS according to the CQI feedback configuration. If N is one, the CQI is calculated on a single antenna port, antenna port 7, and the single antenna port is mapped from the N equals one CSI-RS antenna port.

A user equipment (UE) communicating with a base station (BS) is provided. The UE comprises a transceiver configured to receive N channel state information reference signal (CSI-RS) on N CSI-RS antenna ports from the BS. A transmission mode is configured that supports coordinated multi-point (COMP) transmissions. A channel quality information (CQI) feedback configuration requires CQI feedback without a precoding matrix index (PMI) and without a rank indicator (RI). The UE comprises processing circuitry configured to transmit a CQI to the BS according to the CQI feedback configuration. If N is one, the CQI is calculated on a single antenna port, antenna port 7, and the single antenna port is mapped from the N equals one CSI-RS antenna port.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. As used herein, the phrase “substantially similar” means “substantially similar and/or the same as.” It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a wireless network according to embodiments of the present disclosure;

FIG. 2A illustrates a high-level diagram of a wireless transmit path according to embodiments of the present disclosure;

FIG. 2B illustrates a high-level diagram of a wireless receive path according to embodiments of the present disclosure;

FIG. 3 illustrates a subscriber station according to embodiments of the present disclosure;

FIG. 4 illustrates a table for mapping a CSI reference signal for a normal cyclic prefix according to embodiments of the present disclosure;

FIG. 5 illustrates a table for mapping a CSI reference signal for an extended cyclic prefix according to embodiments of the present disclosure;

FIG. 6 illustrates a mapping of mini-PRBs to a PRB pair according to embodiments of the present disclosure; and

FIG. 7 illustrates a flow diagram for CQI transmission and reception in a multiple input multiple output (MIMO) communication system according to embodiments of the present disclosure.

### DETAILED DESCRIPTION

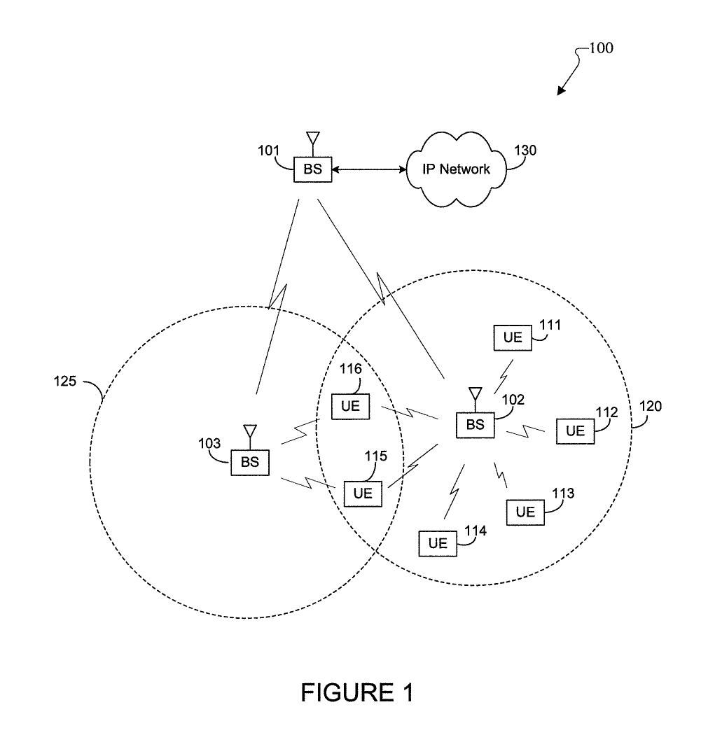

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications system. As used herein, the term “port” may be synonymously with “antenna ports,” such as channel state information reference signal (CSI-RS) ports may be referenced as CSI-RS antenna ports and demodulation reference signal (DMRS) ports may be referenced as DMRS antenna ports, and vice versa.

The following documents and standards descriptions are hereby incorporated into the present disclosure as if fully set forth herein: 3GPP TS 36.211 v10.1.0, “E-UTRA, Physical channels and modulation” (REF1); 3GPP TS 36.212 v10.1.0, “E-UTRA, Multiplexing and Channel coding (REF2); and 3GPP TS 36.213 v10.1.0, “E-UTRA, Physical Layer Procedures” (REF3).

FIG. 1 illustrates a wireless network 100 according to one embodiment of the present disclosure. The embodiment of wireless network 100 illustrated in FIG. 1 is for illustration only. Other embodiments of wireless network 100 could be used without departing from the scope of this disclosure.

The wireless network 100 includes base station (BS) 101, BS 102, and BS 103. The BS 101 communicates with BS 102 and BS 103. BS 101 also communicates with Internet protocol (IP) network 130, such as the Internet, a proprietary IP network, or other data network.

Depending on the network type, other well-known terms may be used instead of “base station,” such as “base station” (BS), “access point” (AP), or “eNodeB” (eNB). For the sake of convenience, the term base station (BS) shall be used herein to refer to the network infrastructure components that provide wireless access to remote terminals. In addition, the term user equipment (UE) is used herein to refer to remote terminals that can be used by a consumer to access services via the wireless communications network via that wirelessly accesses an BS, whether the UE is a mobile device (e.g., cell phone) or is normally considered a stationary device (e.g., desktop personal computer, vending machine, etc.). In other systems, other well-known terms may be used instead of “user equipment”, such as “mobile station” (MS), “subscriber station” (SS), “remote terminal” (RT), “wireless terminal” (WT), and the like.

The BS 102 provides wireless broadband access to network 130 to a first plurality of user equipments (UEs) within coverage area 120 of BS 102. The first plurality of UEs includes UE 111, which may be located in a small business; UE 112, which may be located in an enterprise; UE 113, which may be located in a WiFi hotspot; UE 114, which may be located in a first residence; UE 115, which may be located in a second residence; and UE 116, which may be a mobile device, such as a cell phone, a wireless laptop, a wireless PDA, or the like. UEs 111-116 may be any wireless communication device, such as, but not limited to, a mobile phone, mobile PDA and any mobile station (MS).

BS 103 provides wireless broadband access to a second plurality of UEs within coverage area 125 of BS 103. The second plurality of UEs includes UE 115 and UE 116. In some embodiments, one or more of BS s 101-103 may communicate with each other and with UEs 111-116 using LTE or LTE-A techniques including techniques for: Channel Quality Indicator (CQI) feedback without spatial feedback for TDD coordinated multi-point and carrier aggregation as described in embodiments of the present disclosure.

Dotted lines show the approximate extents of coverage areas 120 and 125, which are shown as approximately circular for the purposes of illustration and explanation only. It should be clearly understood that the coverage areas associated with base stations, for example, coverage areas 120 and 125, may have other shapes, including irregular shapes, depending upon the configuration of the base stations and variations in the radio environment associated with natural and man-made obstructions.

Although FIG. 1 depicts one example of a wireless network 100, various changes may be made to FIG. 1. For example, another type of data network, such as a wired network, may be substituted for wireless network 100. In a wired network, network terminals may replace BS s 101-103 and UEs 111-116. Wired connections may replace the wireless connections depicted in FIG. 1.

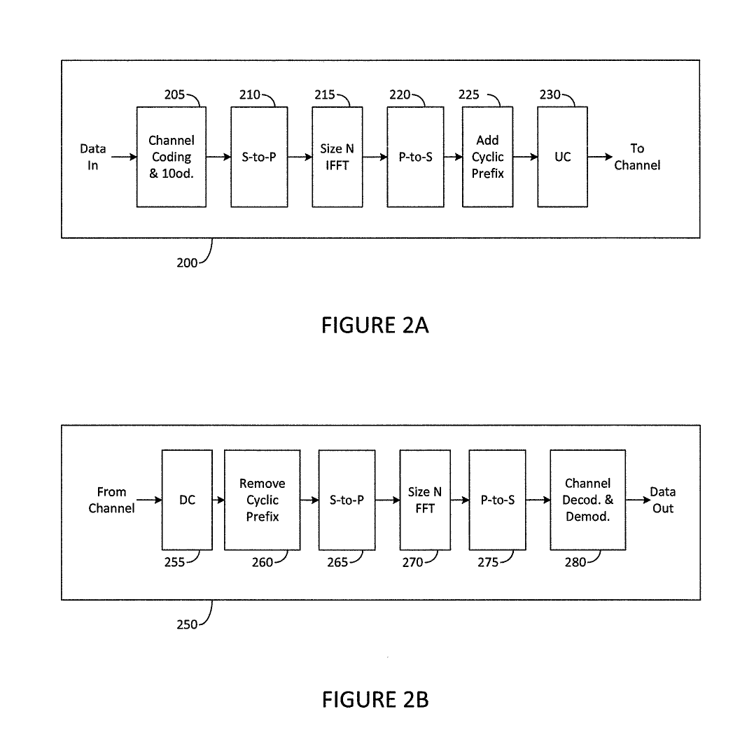

FIG. 2A is a high-level diagram of a wireless transmit path. FIG. 2B is a high-level diagram of a wireless receive path. In FIGS. 2A and 2B, the transmit path 200 may be implemented, e.g., in BS 102 and the receive path 250 may be implemented, e.g., in a UE, such as UE 116 of FIG. 1. It will be understood, however, that the receive path 250 could be implemented in a BS (e.g., BS 102 of FIG. 1) and the transmit path 200 could be implemented in a UE. In certain embodiments, transmit path 200 and receive path 250 are configured to perform methods for Channel Quality Indicator (CQI) feedback without spatial feedback for TDD coordinated multi-point and carrier aggregation as described in embodiments of the present disclosure.

Transmit path 200 comprises channel coding and modulation block 205, serial-to-parallel (S-to-P) block 210, Size N Inverse Fast Fourier Transform (IFFT) block 215, parallel-to-serial (P-to-S) block 220, add cyclic prefix block 225, and up-converter (UC) 230. Receive path 250 comprises down-converter (DC) 255, remove cyclic prefix block 260, serial-to-parallel (S-to-P) block 265, Size N Fast Fourier Transform (FFT) block 270, parallel-to-serial (P-to-S) block 275, and channel decoding and demodulation block 280.

At least some of the components in FIGS. 2A and 2B may be implemented in software while other components may be implemented by configurable hardware (e.g., one or more processors) or a mixture of software and configurable hardware. In particular, it is noted that the FFT blocks and the IFFT blocks described in this disclosure document may be implemented as configurable software algorithms, where the value of Size N may be modified according to the implementation.

Furthermore, although this disclosure is directed to an embodiment that implements the Fast Fourier Transform and the Inverse Fast Fourier Transform, this is by way of illustration only and should not be construed to limit the scope of the disclosure. It will be appreciated that in an alternate embodiment of the disclosure, the Fast Fourier Transform functions and the Inverse Fast Fourier Transform functions may easily be replaced by Discrete Fourier Transform (DFT) functions and Inverse Discrete Fourier Transform (IDFT) functions, respectively. It will be appreciated that for DFT and IDFT functions, the value of the N variable may be any integer number (i.e., 1, 2, 3, 4, etc.), while for FFT and IFFT functions, the value of the N variable may be any integer number that is a power of two (i.e., 1, 2, 4, 8, 16, etc.).

In transmit path 200, channel coding and modulation block 205 receives a set of information bits, applies coding (e.g., LDPC coding) and modulates (e.g., Quadrature Phase Shift Keying (QPSK) or Quadrature Amplitude Modulation (QAM)) the input bits to produce a sequence of frequency-domain modulation symbols. Serial-to-parallel block 210 converts (i.e., de-multiplexes) the serial modulated symbols to parallel data to produce N parallel symbol streams where N is the IFFT/FFT size used in BS 102 and UE 116. Size N IFFT block 215 then performs an IFFT operation on the N parallel symbol streams to produce time-domain output signals. Parallel-to-serial block 220 converts (i.e., multiplexes) the parallel time-domain output symbols from Size N IFFT block 215 to produce a serial time-domain signal. Add cyclic prefix block 225 then inserts a cyclic prefix to the time-domain signal. Finally, up-converter 230 modulates (i.e., up-converts) the output of add cyclic prefix block 225 to RF frequency for transmission via a wireless channel. The signal may also be filtered at baseband before conversion to RF frequency.

The transmitted RF signal arrives at UE 116 after passing through the wireless channel and reverse operations to those at BS 102 are performed. Down-converter 255 down-converts the received signal to baseband frequency and remove cyclic prefix block 260 removes the cyclic prefix to produce the serial time-domain baseband signal. Serial-to-parallel block 265 converts the time-domain baseband signal to parallel time domain signals. Size N FFT block 270 then performs an FFT algorithm to produce N parallel frequency-domain signals. Parallel-to-serial block 275 converts the parallel frequency-domain signals to a sequence of modulated data symbols. Channel decoding and demodulation block 280 demodulates and then decodes the modulated symbols to recover the original input data stream.

Each of BSs 101-103 may implement a transmit path that is analogous to transmitting in the downlink to UEs 111-116 and may implement a receive path that is analogous to receiving in the uplink from UEs 111-116. Similarly, each one of UEs 111-116 may implement a transmit path corresponding to the architecture for transmitting in the uplink to BSs 101-103 and may implement a receive path corresponding to the architecture for receiving in the downlink from BSs 101-103.

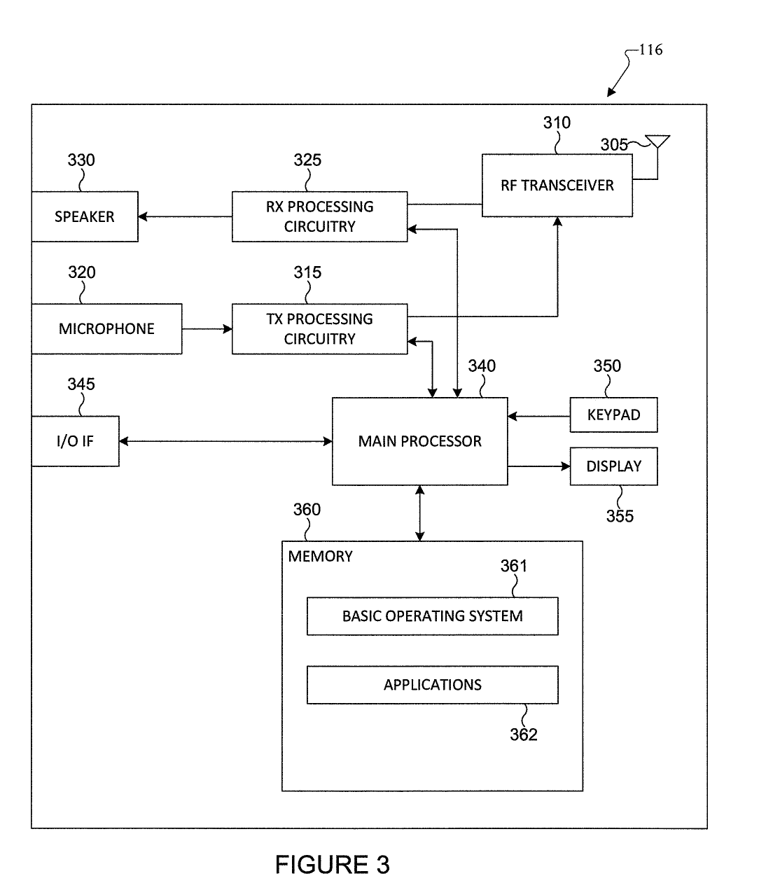

FIG. 3 illustrates a subscriber station according to embodiments of the present disclosure. The embodiment of subscriber station, such as UE 116, illustrated in FIG. 3 is for illustration only. Other embodiments of the wireless subscriber station could be used without departing from the scope of this disclosure. Although UE 116 is depicted byway of example, the description of FIG. 3 can apply equally to any of UE 111, UE 112, UE 113, UE 114 and UE 115

UE 116 comprises antenna 305, radio frequency (RF) transceiver 310, transmit (TX) processing circuitry 315, microphone 320, and receive (RX) processing circuitry 325. SS 116 also comprises speaker 330, main processor 340, input/output (I/O) interface (IF) 345, keypad 350, display 355, and memory 360. Memory 360 further comprises basic operating system (OS) program 361 and a plurality of applications 362.

Radio frequency (RF) transceiver 310 receives from antenna 305 an incoming RF signal transmitted by a base station of wireless network 100. Radio frequency (RF) transceiver 310 down-converts the incoming RF signal to produce an intermediate frequency (IF) or a baseband signal. The IF or baseband signal is sent to receiver (RX) processing circuitry 325 that produces a processed baseband signal by filtering, decoding, and/or digitizing the baseband or IF signal. Receiver (RX) processing circuitry 325 transmits the processed baseband signal to speaker 330 (i.e., voice data) or to main processor 340 for further processing (e.g., web browsing).

Transmitter (TX) processing circuitry 315 receives analog or digital voice data from microphone 320 or other outgoing baseband data (e.g., web data, e-mail, interactive video game data) from main processor 340. Transmitter (TX) processing circuitry 315 encodes, multiplexes, and/or digitizes the outgoing baseband data to produce a processed baseband or IF signal. Radio frequency (RF) transceiver 310 receives the outgoing processed baseband or IF signal from transmitter (TX) processing circuitry 315. Radio frequency (RF) transceiver 310 up-converts the baseband or IF signal to a radio frequency (RF) signal that is transmitted via antenna 305.

In certain embodiments, main processor 340 is a microprocessor or microcontroller. Memory 360 is coupled to main processor 340. According to some embodiments of the present disclosure, part of memory 360 comprises a random access memory (RAM) and another part of memory 360 comprises a Flash memory, which acts as a read-only memory (ROM).

Main processor 340 can be comprised of one or more processors and executes basic operating system (OS) program 361 stored in memory 360 in order to control the overall operation of wireless subscriber station 116. In one such operation, main processor 340 controls the reception of forward channel signals and the transmission of reverse channel signals by radio frequency (RF) transceiver 310, receiver (RX) processing circuitry 325, and transmitter (TX) processing circuitry 315, in accordance with well-known principles.

Main processor 340 is capable of executing other processes and programs resident in memory 360, such as operations for Channel Quality Indicator (CQI) feedback without spatial feedback for TDD coordinated multi-point and carrier aggregation as described in embodiments of the present disclosure. Main processor 340 can move data into or out of memory 360, as required by an executing process. In some embodiments, the main processor 340 is configured to execute a plurality of applications 362, such as applications for CoMP communications and MU-MIMO communications, including uplink control channel multiplexing in beamformed cellular systems. Main processor 340 can operate the plurality of applications 362 based on OS program 361 or in response to a signal received from BS 102. Main processor 340 is also coupled to I/O interface 345. I/O interface 345 provides subscriber station 116 with the ability to connect to other devices such as laptop computers and handheld computers. I/O interface 345 is the communication path between these accessories and main controller 340.

Main processor 340 is also coupled to keypad 350 and display unit 355. The operator of subscriber station 116 uses keypad 350 to enter data into subscriber station 116. Display 355 may be a liquid crystal display capable of rendering text and/or at least limited graphics from web sites. Alternate embodiments may use other types of displays.

In time division duplexing (TDD), PMI is not required by BS 102 and BS 102 may configure UE 116 to not report PMI/rank indication (RI), i.e., UE 116 may be configured without PMI/RI reporting. This allows the network to reduce overhead on the uplink. In this case, there is a need to specify a precoder UE 116 assumes for deriving channel quality information (CQI). In 3^{rd} Generation Partnership Project (3GPP) evolved universal terrestrial radio access (E-UTRA) Release-10 systems, the solution used is to derive CQI feedback at UE 116 based on open loop transmission based on cell-specific reference signal (CRS).

Table 7.2.3-0 of REF3, reprinted below, indicates a physical downlink shared channel (PDSCH) transmission scheme assumed for a CSI reference resource.

TABLE 7.2.3-0
PDSCH transmission scheme assumed for a CSI reference resource.

| Transmission | |
|---|---|
| mode | Transmission scheme of PDSCH |
| 1 | Single-antenna port, port 0 |
| 2 | Transmit diversity |
| 3 | Transmit diversity if the associated rank |
| | indicator is 1, otherwise large delay CDD |
| 4 | Closed-loop spatial multiplexing |
| 5 | Multi-user MIMO |
| 6 | Closed-loop spatial multiplexing with a |
| | single transmission layer |
| 7 | If the number of PBCH antenna ports is |
| | one, Single-antenna port, port 0; |
| | otherwise Transmit diversity |
| 8 | If the UE is configured without PMI/RI |
| | reporting: if the number of PBCH |
| | antenna ports is one, single-antenna |
| | port, port 0; otherwise transmit diversity |
| | If the UE is configured with PMI/RI |
| | reporting: closed-loop spatial |
| | multiplexing |
| 9 | If the UE is configured without PMI/RI |
| | reporting: if the number of PBCH |
| | antenna ports is one, single-antenna |
| | port, port 0; otherwise transmit diversity |
| | If the UE is configured with PMI/RI |
| | reporting: if the number of CSI-RS ports |
| | is one, single-antenna port, port 7; |
| | otherwise up to 8 layer transmission, |
| | ports 7-14 (see subclause 7.1.5B) |

There are situations when CRS is not available for measurements. This could happen, for example in following cases:

Coordinated Multi-point Transmission (COMP): With CoMP, UE 116 may be setup with multiple CSI-RS configurations. However, currently there is no CRS associated with each CSI-RS. So per base station feedback needs to be further considered for TDD if no PMI/RI reporting is configured.

New Carrier Type (NCT): NCT is essentially a carrier without legacy CRS transmissions. NCT is configured as a secondary carrier (serving cell) and an anchor cell usually supports CRS transmissions

Stand alone Carrier Type (SCT): SCT is a carrier without legacy CRS transmissions, but also could be the primary carrier/serving cell.

Coordinated Multi-Point (CoMP) transmission and reception techniques facilitate cooperative communications across multiple transmission and reception points (e.g., cells) for LTE-Advanced (LTE-A) systems. In CoMP operation, multiple points coordinate with each other in such a way to improve signal quality to a user with interference avoidance and joint transmission techniques.

The technology of CoMP that allows a UE, such as UE 116, to receive signals from multiple base stations (BSs) and the deployment scenarios considered are:

Scenario 1: Homogeneous network with intra-site CoMP.

Scenario 2: Homogeneous network with high transmit (Tx) power remote radio heads (RRHs).

Scenario 3: Heterogeneous network with low power RRHs within the macrocell coverage where the transmission/reception points created by the RRHs have different cell IDs as the macro cell.

Scenario 4: Heterogeneous network with low power RRHs within the macrocell coverage where the transmission/reception points created by the RRHs have the same cell IDs as the macro cell.

Identified CoMP schemes include: Joint transmission; Dynamic point selection (DPS), including dynamic point blanking; and Coordinated scheduling/beamforming, including dynamic point blanking.

With each hypothesis of different CoMP transmission schemes, the network needs to know the CQI/PMI/RI supported by the UE to optimize scheduling. The feedback definitions and measurements in the current specification are defined for a single-cell transmission. Further, individual CoMP scheme performance is characterized by other parameters, including: the base stations (BSs) used in the CoMP scheme; precoding applied at each of the one or more transmitting BSs; the BSs that are blanked or not transmitting; and the interference measurement resource that may be configured for measurement of individual CQIs.

Channel state in formation-reference signal (CSI-RS) is provided to enable channel measurements to a UE and demodulation reference signals (DMRSs) are used for demodulation with transmission mode 9.

A UE specific CSI-RS configuration includes: a non-zero power CSI-RS resource; and one or more zero-power CSI-RS resources.

Typically, the non-zero CSI-RS resource corresponds to the antenna elements or ports of a serving cell, e.g., BS 102. Zero-power CSI-RSs, also commonly referred to as muted CSI-RSs, are used to protect the CSI-RS resources of another cell and a UE is expected to rate match (skip for decoding/demodulation) around these resources.

CSI reference signals are transmitted on one, two, four, or eight antenna ports using p=15, p=15,16, p=15, . . . ,18 and p=15, . . . ,22, respectively. CSI reference signals are defined for Δf=15 kHz only.

A reference-signal sequence r_{l,n}_{ₛ}(m) is defined by Equation 1:

$${r}_{l , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , {N}_{RB}^{max , DL} - 1 \qquad ( 1 )$$

where nₛ is the slot number within a radio frame and l is the OFDM symbol number within the slot. The pseudo-random sequence c(i) is defined in Section 7.2 of REF1. The pseudo-random sequence generator shall be initialized with cᵢₙᵢₜ=2¹⁰·(7·(nₛ+1)+l+1)·(2·N_{ID}^{cell}+1)+2·N_{ID}^{cell}+N_{CP} at the start of each OFDM symbol where:

$${N}_{CP} = \{ \begin{matrix}1 & for normal CP \\ 0 & for extended CP .\end{matrix}$$

Mapping to Resource Elements

In subframes configured for CSI reference signal transmission, the reference signal sequence r_{l,n}_{ₛ}(m) is mapped to complex-valued modulation symbols a_{k,l}^{(p)} used as reference symbols on antenna port p according to Equation 2:

$${a}_{k , l}^{( p )} = {w}_{{l}^{″}} \cdot {r}_{l , {n}_{s}} ( {m}^{′} ) \\ where \\ k = {k}^{′} + 12 m + \{ \begin{matrix}- 0 & for p ∈ \{ 15 , 16 \} , normal cyclic prefix \\ - 6 & for p ∈ \{ 17 , 18 \} , normal cyclic prefix \\ - 1 & for p ∈ \{ 19 , 20 \} , normal cyclic prefix \\ - 7 & for p ∈ \{ 21 , 22 \} , normal cyclic prefix \\ - 0 & for p ∈ \{ 15 , 16 \} , extended cyclic prefix \\ - 3 & for p ∈ \{ 17 , 18 \} , extended cyclic prefix \\ - 6 & for p ∈ \{ 19 , 20 \} , extended cyclic prefix \\ - 9 & for p ∈ \{ 21 , 22 \} , extended cyclic prefix\end{matrix} \\ l = {l}^{′} + \{ \begin{matrix}{l}^{″} & CSI reference signal configurations 0 \text{-} 19 , normal cyclic prefix \\ 2 {l}^{″} & CSI reference signal configurations 20 \text{-} 31 , normal cyclic prefix \\ {l}^{″} & CSI reference signal configurations 0 \text{-} 27 , extended cyclic prefix\end{matrix} \\ {w}_{{l}^{″}} = \{ \begin{matrix}1 & p ∈ \{ 15 , 17 , 19 , 21 \} \\ {( - 1 )}^{{l}^{″}} & p ∈ \{ 16 , 18 , 20 , 22 \}\end{matrix} \\ {l}^{″} = 0 , 1 \\ m = 0 , 1 , … , {N}_{RB}^{DL} - 1 \\ {m}^{′} = m + ⌊ \frac{{N}_{RB}^{max , DL} - {N}_{RB}^{DL}}{2} ⌋ . \qquad ( 2 )$$

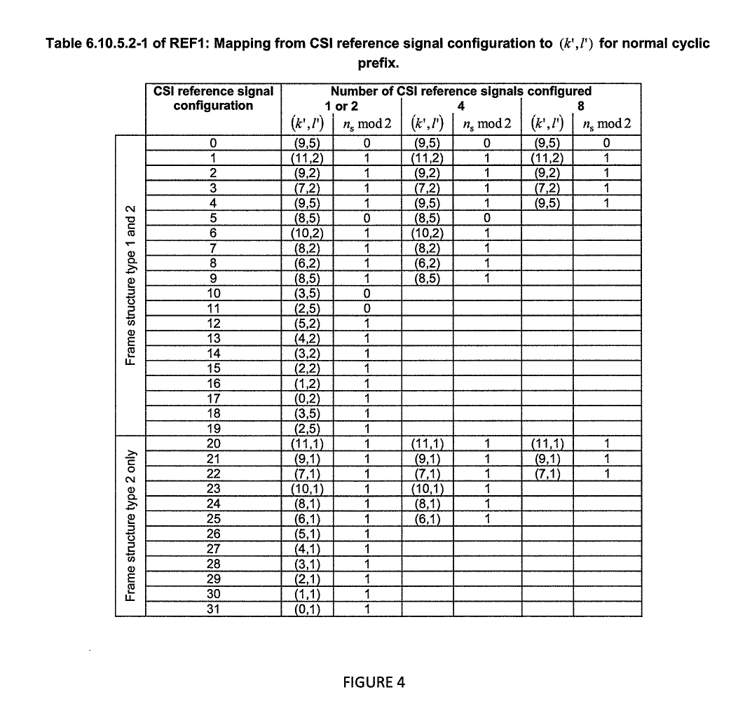

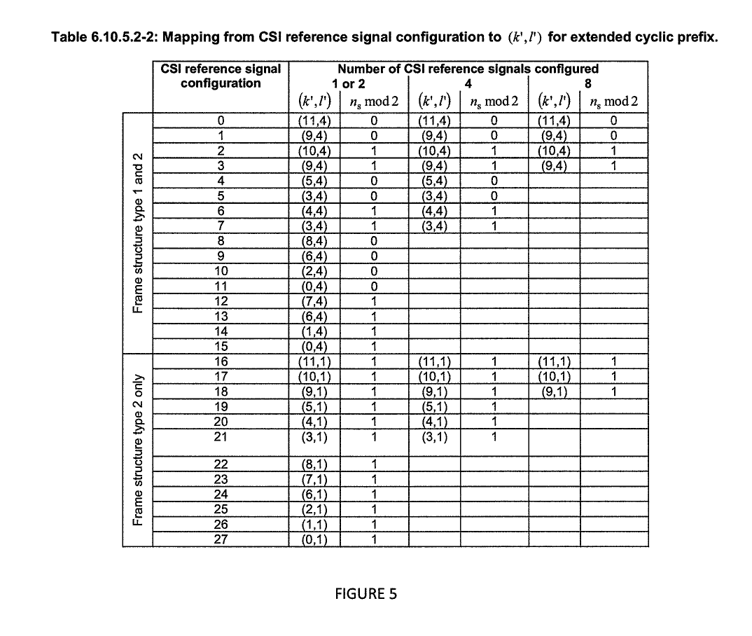

The quantity (k′,l′) and the necessary conditions on nₛ are given by Table 6.10.5.2-1 (included as FIG. 4) and Table 6.10.5.2-2 (included as FIG. 5) of REF1 for normal and extended cyclic prefix, respectively.

Multiple CSI reference signal configurations can be used in a given cell, including: zero or one configuration for which UE 116 assumes non-zero transmission power for the CSI-RS; and zero or more configurations for which UE 116 assumes zero transmission power.

For each bit set to one in the 16-bit bitmap ZeroPowerCSI-RS configured by higher layers, UE 116 assumes zero transmission power for the resource elements corresponding to the four CSI reference signal columns in Tables 6.10.5.2-1 and 6.10.5.2-2 of REF1 for normal and extended cyclic prefix, respectively, except for resource elements that overlap with those for which UE 116 assumes non-zero transmission power CSI-RS as configured by higher layers. The most significant bit corresponds to the lowest CSI reference signal configuration index and subsequent bits in the bitmap correspond to configurations with indices in increasing order.

CSI reference signals can only occur in:
downlink slots where nₛ mod2 fulfills the condition in Tables 6.10.5.2-1 and 6.10.5.2-2 of REF1 for normal and extended cyclic prefix, respectively; and
where the subframe number fulfills the conditions in Section 6.10.5.3 of REF1.

UE 116 assumes that CSI reference signals are not to be transmitted:
in the special subframe(s) in case of frame structure type 2;
in subframes where transmission of a CSI-RS would collide with transmission of synchronization signals, physical broadcast channel (PBCH), or SystemInformationBlockType1 messages; and
in subframes configured for transmission of paging messages.

Resource elements (k,l) used for transmission of CSI reference signals on any of the antenna ports in the set S, where S={15}, S={15,16}, S={17,18}, S={19,20} or S={21,22} is:
not be used for transmission of PDSCH on any antenna port in the same slot; and
not be used for CSI reference signals on any antenna port other than those in S in the same slot.

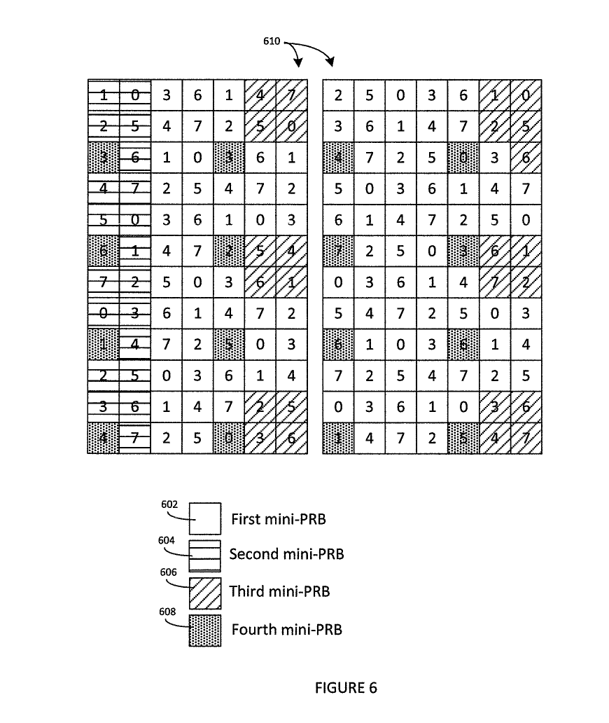

The mapping for CSI reference signal configuration 0 is illustrated in Figures 6.10.5.2-1 and 6.10.5.2-2 of REF1.

CSI Reference Signal Subframe Configuration

The subframe configuration period T_{CSI-RS} and the subframe offset Δ_{CSI-RS} for the occurrence of CSI reference signals are listed in Table 6.10.5.3-1 of REF1. The parameter I_{CSI-RS} can be configured separately for CSI reference signals for which UE 116 assumes non-zero and zero transmission power. Subframes containing CSI reference signals shall satisfy (10n_{f}+└nₛ/2┘−Δ_{CSI-RS})modT_{CSI-RS}=0.

Channel-State Information-Reference Signal (CSI-RS)

The following parameters for CSI-RS are configured via higher layer signaling:
Number of CSI-RS ports. The allowable values and port mapping are given in Section 6.10.5 of REF1.
CSI-RS Configuration (see Table 6.10.5.2-1 and Table 6.10.5.2-2 in REF1)
CSI-RS subframe configuration I_{CSI-RS}. The allowable values are given in Section 6.10.5.3 of REF1.
Subframe configuration period Δ_{CSI-RS}. The allowable values are given in Section 6.10.5.3 of REF1.
Subframe offset Δ_{CSI-RS}. The allowable values are given in Section 6.10.5.3 of REF1.
UE 116 assumption on reference PDSCH transmitted power for CSI feedback P_{c}. P_{c} is the assumed ratio of PDSCH energy per resource element (EPRE) to CSI-RS EPRE when UE 116 derives CSI feedback and takes values in the range of [−8, 15] dB with 1 dB step size, where the PDSCH EPRE corresponds to the symbols for which the ratio of the PDSCH EPRE to the cell-specific RS EPRE is denoted by ρ_{A}, as specified in Table 5.2-2 and Table 5.2-3 of REF3.

UE 116 should not expect the configuration of CSI-RS and/or zero-power CSI-RS and physical multicast channel (PMCH) in the same subframe of a serving cell.

To support CoMP transmission, a network needs feedback corresponding to multiple base stations or cells. So, a network can set-up multiple CSI-RS resources, each typically corresponding to a BS.

CSI-RS can have multiple configurations and parameters. Configuration of multiple non-zero-power CSI-RS resources includes at least: AntennaPortsCount, ResourceConfig, SubframeConfig, P_{c}, and X. Parameter X is used to derive scrambling initialization of Equation 3 below. Parameter X ranges from 0 to 503, can be interpreted as virtual cell id, and can be the physical cell identity (PCI) of the serving cell.

cᵢₙᵢₜ=2¹⁰·(7·(nₛ1)+l+1)·(2·X+1)+2·X+N_{CP} (3)

The CSI-RS parameters are configured per CSI-RS resource. Some parameters can be configured per CSI-RS port considering for multiple BSs in one CSI-RS resource.

While the CSI-RS resources capture channels of individual BSs, the interference measurement also depends on the CoMP scheme. In certain embodiments, a single interference measurement resource is used, which is CRS itself. Interference measurement on CRS captures all the interference outside the cell.

For CoMP, one or more interference measurement resources can be defined to capture the interference for a hypothetical CoMP scheme.

Interference Measurement Resource (IMR) can have multiple configurations. At least one Interference Measurement Resource (IMR) can be configured for a UE that accords with 3GPP TS Release 11. A maximum of only one or multiple IMRs can be configured for UE 116 that accords with 3GPP TS Release 11. Each IMR can comprise only resource elements (Res) that are configured as 3GPP TS Release 10 CSI-RS resources. REs of an IMR are allowed to be configured as non-zero-power CSI-RS resources. An IMR can have finer granularity than 4 REs per physical resource block (PRB).

CQI can be defined so that the eNB configures the CSI(s) to be reported by UE 116. A 3GPP TS Release 11 UE can be configured to report one or more CSIs per component carrier (CC). Each CSI is configured by the association of a channel part and an interference part.

The channel part comprises a non-zero power (NZP) CSI-RS resource in a CoMP Measurement Set. The interference part comprises an Interference Measurement Resource (IMR) which occupies a subset of REs configured as 3GPP TS Release 10 zero power (ZP) CSI-RS. The interference part can also include a configuration of one or two NZP CSI-RS resources and UE 116 can assume which ports the transmission of an isotropic signal is considered interference in addition to the interference measured on the configured IMR.

Multiple CSIs can be configured wherein IMRs associated with different CSIs can be configured independently. If NZP CSI-RS resources are configured, the NZP CSI-RS resources can be different for different CSIs. The maximum number of CSIs can be configurable for one UE.

Subframe subsets can be configured for CSI reporting. If PMI/RI reporting is configured, each CQI is associated with a PMI and an RI. Whether a CQI is for Sub-band or wideband values is an independent consideration.

Certain embodiments in accordance with the present disclosure define CQI for TDD, for when PMI/RI reporting is not configured by the network.

In certain embodiments of the present disclosure that use CoMP based on scenario 3 above, each base station, such as BS 102, is configured with a different cell identification (ID). A network may setup multiple CSI-RSs to a UE, such as UE 116. Alternatively, each CSI-RS can be associated with a CRS by the network.

A CQI can be based on multiple configurations of CRSs. If PMI/RI reporting is not configured, UE 116 reports CQI based on CRS from multiple cells. A network can configure one or more CRSs for CSI measurements at UE 116. The network can indicate the number of antenna ports for each CRS along with an associated cell-ID corresponding to the CRS. On each of the one or more configured CRSs, UE 116 reports CQI as follows: (1) if the number of PBCH antenna ports (or the number of signaled antenna ports) is one, CQI is reported based on single-antenna port transmission scheme, port 0; and (2) otherwise report CQI assuming transmit diversity transmission scheme.

A CQI can be based on CRS and IMR. UE 116 can report CQI based on CRS, but estimating CQI of each CRS is based on interference measured on new resources, which includes an interference part measured on an IMR resource and an interference part measured on one or more non-zero power CSI-RS. The associated IMR and/or non-zero power CSI-RS resources for interference measurement may be configured for UE 116 by the network. If UE 116 is configured without PMI/RI reporting, UE 116 reports CQI based on CRS for channel measurement and IMR and/or non-zero power CSI-RS for interference measurement. Alternatively, if UE 116 is configured without PMI/RI reporting, UE 116 can be configured to report a first CQI based on channel measurement on CRS and a first IMR resource; and a second CQI based on CRS and a second IMR resource.

In certain embodiments, when PMI/RI reporting is not configured, an implicit association is assumed for CQI reporting, based on the number of configured CSI-RS configurations or the number of configured non-zero power CSI-RS configurations. As an example, if no non-zero power CSI-RS configurations are configured for UE 116, UE 116 measures CQI based on CRS. Additionally, if one or more non-zero power CSI-RS configurations are configured for UE 116, then UE 116 measures CQI based on CSI-RS.

In certain embodiments, if no PMI/RI reporting is configured, UE 116 uses a new transmit diversity transmission scheme based on DMRS. More specifically, UE 116 assumes that the channel based on CSI-RS is used to perform the transmission as defined by the transmission scheme, but using DMRS, as in the example schemes below.

Scheme 1: Transmit Diversity

A transmit diversity scheme can be space time block code (STBC) or space frequency block code (SFBC) transmit diversity based on one or more DMRS ports. As an example, when two DMRS ports are used, the transmit diversity scheme would be based on two DMRS ports, ports {7,8} or ports {7, 9}.

In another example, the transmit diversity scheme could be based on precoder cycling. Such precoder cycling could be: (1) inter PRE precoder cycling and (2) intra-PRE precoder cycling as described below in schemes 2 and 3.

Scheme 2: Single Port DMRS (Inter-PRB Precoder Cycling)

With inter-PRB precoder cycling, UE 116 assumes transmission based on a precoder pattern applied over PRBs or sets of PRBs. The precoder pattern can be fixed or configured by the network and communicated to UE 116.

Scheme 3: Multi-Port DMRS (Intra-PRE Precoder Cycling Using Mini-PRBs)

With intra-PRB precoder cycling, UE 116 assumes that individual DMRS ports (e.g., port 7, 8, 9, 10) are precoded with different precoders, and each port applies for decoding of an associated subset of REs in the PRB. Such precoder pattern may be fixed or configured for UE 116.

N precoder Codeword (CW)/PRB pair 610 can be used by the transmitter, wherein each port corresponds to a mini-PRB 602-608 within PRB pair 610. Each mini-PRB 602-608 is a subset of REs within PRB pair 610. Mini-PRBs 602-608 are defined and UE 116 decodes each mini-PRB 602-608 based on one of N DMRS ports. N could take values of 1, 2 or 4 and can be configurable by the network. In one example, N=1, 2, and 4, which respectively corresponds to DMRS ports {7}, {7, 8} and {7, 8, 9, 10}. In another example, N=1, which corresponds to one of DMRS ports {7}, {8}, {9} and {10}, and the DMRS port is configurable. In another example, N=2, which corresponds to one of DMRS ports {7,8} and {9,10} and the DMRS ports are configurable. Cycling within PRB pair 610 can achieve higher diversity for smaller allocation sizes (e.g, 1 RB, 2 RB). Additionally, the value of N may depend on a size of allocation.

FIG. 6 illustrates a mapping of mini-PRBs to a PRB pair according to embodiments of the present disclosure. The embodiment illustrated in FIG. 6 is for illustration only. Other embodiments with different mappings could be used without departing from the scope of this disclosure.

As shown in FIG. 6, eight resource element groups (REGs) can be indexed 0-7, where one or two reference element groups (REGs) (also referred to as control channel elements (CCEs), or a group of REs) can be assigned to one of mini-PRBs 602-608 and each mini-PRB 602-608 is in turn assigned to a DMRS port. As an example, mini-PRB 602 can be assigned to DMRS Port 7, mini-PRB 604 can be assigned to DMRS port 8, mini-PRB 606 can be assigned to DMRS port 9, and mini-PRB 608 can be assigned to DMRS port 10. One or more mini-PRBs 602-608 can be mapped to one or more DMRS ports.

In certain embodiments, the CQI is calculated and reported based upon a single CSI-RS port. If no PMI/RI reporting is configured, UE 116 reports CQI based on a single port CSI-RS.

The number of CSI-RS ports for each CSI configuration can be limited to one if PMI/RI reporting is not configured. In other words, UE 116 is not expected to receive a configuration of “no PMI/RI reporting” and a CSI configuration with more than one antenna port.

Alternatively, the number of CSI-RS ports for one or more CSI configurations can be greater than one. In such a case, UE 116 can be required to report CSI based on a single CSI-RS port and a port index may be fixed or configurable by the network.

When the network configures CQI reporting to TDD UE 116, the network can apply an antenna virtualization precoding vector to the CSI-RS on the single antenna port. In some cases, the network (or the base station) can select the precoding vector to be aligned with an instantaneous channel vector between BS 102 and UE 116. The instantaneous channel vector can be obtained by uplink sounding relying on channel reciprocity.

Alternatively, the network (or BS 102) can select a precoding vector to be used for the downlink transmission for UE 116, where the precoding vector can be selected at least partly utilizing an instantaneous channel vector.

When UE 116 derives a CQI utilizing a received CSI-RS on the single antenna port, UE 116 effectively derives the CQI when the precoding vector is applied. Upon receiving the CQI from UE 116, the network can have a good knowledge on the CQI when the network applies the precoding vector so that the network can utilize the CQI for selecting a modulation coding scheme (MCS) for a downlink transmission when applying the precoding vector for the downlink transmission.

In certain embodiments, the CQI is reported via multiple CSI-RS ports. If no PMI/RI reporting is configured, UE 116 reports CQI based on multiple CSI-RS ports in a CSI-RS configuration, but assumes no precoding. More specifically, UE 116 assumes the channels on CSI-RS antenna ports are one to one mapped to DMRS ports 7-14. As an example, if two CSI-RS ports in a CSI-RS configuration are configured, UE 116 assumes mapping of first CSI-RS port to DMRS port 7 and second CSI-RS port to DMRS port 8. As another example, if N CSI-RS ports in a CSI-RS configuration are configured, UE 116 assumes mapping of CSI-RS ports to DMRS ports 7 to 7+(N−1). The rank of transmission is assumed to be the same as that of the number of CSI-RS ports for reference physical downlink shared channel (PDSCH) transmission scheme.

This is similar to applying multiple ranks to the single CSI-RS scheme described above, which allows for multiple transmission layers (streams) to be transmitted to UE 116.

When the network uses multiple CSI-RS ports for configuring CQI reporting to TDD UE 116, the network can apply an antenna virtualization precoding matrix to the CSI-RS on the multiple antenna ports, where each antenna port carries a CSI-RS precoded with each column vector of a precoding matrix.

In some cases, the network (or BS 102) can select the precoding matrix to be aligned with an instantaneous channel matrix between BS 102 and UE 116. The instantaneous channel matrix can be obtained by uplink sounding relying on channel reciprocity.

In some other cases, the network (or BS 102) selects the precoding matrix to be used for the downlink transmission for the UE, where the precoding matrix is selected at least partly utilizing the instantaneous channel matrix.

When UE 116 derives one or more CQIs utilizing the received CSI-RSs on the multiple antenna ports, UE 116 effectively derives the one or more CQIs when the precoding matrix is applied. Upon receiving the one or more CQIs from UE 116, the network can have a good knowledge on the CQIs when the network applies the precoding matrix, and hence the network may utilize the CQIs for selecting one or more MCSs for a downlink transmission to one or more UEs when applying the precoding matrix for the downlink transmission.

When a two MIMO-codeword downlink transmission is assumed for CQI reporting, the number of reported CQIs is two, one each per MIMO codeword. In addition, when the network schedules a two MIMO-codeword transmission, the number of MCSs can be two, one each per MIMO codeword.

In one method, if UE 116 is configured without PMI/RI reporting: if the number of CSI-RS ports is one, single-antenna port, port 7; otherwise up to 8 layer transmission with ports 7-14. For up to eight layer transmission scheme of the PDSCH, UE 116 can assume that an eNB transmission on the PDSCH would be performed with up to 8 transmission layers on antenna ports 7-14 as defined in Section 6.3.4.4 of Reference 1, which is equivalent to using an identity precoding matrix.

Additionally, UE 116 can use reporting modes 2-0, 3-0 for aperiodic physical uplink shared channel (PUSCH) based feedback or modes 1-0, 2-0 for periodic physical uplink control channel (PUCCH) based feedback. A single codeword CQI (rank 1 CQI) is supported in these x−0 type modes with an exception for transmission mode 3. Higher rank CQIs can be supported by higher ranks based on DMRS ports 7-14. Additionally, new feedback modes may also be defined.

For these embodiments REFS can be amended to include the alternatives provided below:

Higher Layer-configured subband feedback

Mode 3-0 description:

UE 116 reports a wideband CQI value that is calculated assuming transmission on set S subbands.

UE 116 also reports one subband CQI value for each set S subband. The subband CQI value is calculated assuming transmission only in the subband.

Both the wideband and subband CQI represent channel quality for the first codeword, even when RI>1.

For transmission mode 3 the reported CQI values are calculated conditioned on the reported RI. For other transmission modes they are reported conditioned on rank 1.

In a first alternative, for transmission mode x, the reported CQI values are conditioned on the number of CSI-RS ports.

In a second alternative, for transmission mode x, the reported CQI values are calculated conditioned on the reported RI.

In a third alternative, for transmission mode x, the rank on which the reported CQI values are conditioned is the number of non-zero CSI-RS ports configured for the aperiodic CQI reporting.

UE-selected subband feedback

Mode 2-0 Description:

UE 116 selects a set of M preferred subbands of size k (where k and M are given in Table 7.2.1-5 for each system bandwidth range) within the set of subbands S.

UE 116 also reports one CQI value reflecting transmission only over the M selected subbands determined in the previous step. The CQI represents channel quality for the first codeword, even when RI>1.

Additionally, UE 116 also reports one wideband CQI value that is calculated assuming transmission on set S subbands. The wideband CQI represents channel quality for the first codeword, even when RI>1.

For transmission mode 3 the reported CQI values are calculated conditioned on the reported RI. For other transmission modes they are reported conditioned on rank 1.

In a first alternative for transmission mode x, the reported CQI values are conditioned on the number of CSI-RS ports.

In a second alternative, for transmission mode x, the reported CQI values are calculated conditioned on the reported RI.

In a third alternative, for transmission mode x, the rank on which the reported CQI values are conditioned is the number of non-zero CSI-RS ports configured for the aperiodic CQI reporting.

Similar change can be made for feedback modes 1-0 (wideband feedback) and 2-0 (UE selected feedback) in section 7.2.2 of REF3 as marked below.

Wideband feedback

Mode 1-0 description:

In the subframe where RI is reported (only for transmission mode 3):

UE 116 determines a RI assuming transmission on set S subbands.

UE 116 reports a type 3 report consisting of one RI.

In the subframe where CQI is reported:

UE 116 reports a type 4 report consisting of one wideband CQI value which is calculated assuming transmission on set S subbands. The wideband CQI represents channel quality for the first codeword, even when RI>1.

For transmission mode 3 the CQI is calculated conditioned on the last reported periodic RI. For other transmission modes it is calculated conditioned on transmission rank 1.

In a first alternative, for transmission mode x, the reported CQI values are conditioned on the number of CSI-RS ports.

In a second alternative, for transmission mode x, the reported CQI values are calculated conditioned on the reported RI.

In a third alternative, for transmission mode x, the rank on which the reported CQI values are conditioned is the number of non-zero CSI-RS ports configured for the periodic CQI reporting.

UE Selected subband feedback

Mode 2-0 description:

In the subframe where RI is reported (only for transmission mode 3):

UE 116 determines a RI assuming transmission on set S subbands.

UE 116 reports a type 3 report consisting of one RI.

In the subframe where wideband CQI is reported:

UE 116 reports a type 4 report on each respective successive reporting opportunity consisting of one wideband CQI value which is calculated assuming transmission on set S subbands. The wideband CQI represents channel quality for the first codeword, even when RI>1.

For transmission mode 3 the CQI is calculated conditioned on the last reported periodic RI. For other transmission modes it is calculated conditioned on transmission rank 1.

In a first alternative, for transmission mode x, the reported CQI values are conditioned on the number of CSI-RS ports.

In a second alternative, for transmission mode x, the reported CQI values are calculated conditioned on the reported RI.

In a third alternative, for transmission mode x, the rank on which the reported CQI values are conditioned is the number of non-zero CSI-RS ports configured for the periodic CQI reporting.

In the subframe where CQI for the selected subbands is reported:

UE 116 selects the preferred subband within the set of Nⱼ subbands in each of the J bandwidth parts where J is given in Table 7.2.2-2.

UE 116 reports a type 1 report consisting of one CQI value reflecting transmission only over the selected subband of a bandwidth part determined in the previous step along with the corresponding preferred subband L-bit label. A type 1 report for each bandwidth part will in turn be reported in respective successive reporting opportunities. The CQI represents channel quality for the first codeword, even when RI>1.

For transmission mode 3 the preferred subband selection and CQI values are calculated conditioned on the last reported periodic RI. For other transmission modes, the preferred subband selection and CQI values are calculated conditioned on transmission rank 1.

In a first alternative, for transmission mode x, the reported CQI values are conditioned on the number of CSI-RS ports.

In a second alternative, for transmission mode x, the reported CQI values are calculated conditioned on the reported RI.

In a third alternative, for transmission mode x, the rank on which the reported CQI values are conditioned is the number of non-zero CSI-RS ports configured for the periodic CQI reporting.

RI reporting can be supported based on CSI-RS as described later, in which case the text of the second and third alternatives is used.

Additionally, “transmission mode x” in the above texts can be replaced with a new condition, “If UE 116 is configured without PMI/RI reporting and number of CSI-RS ports>1 and CSI reference is based on CSI-RS”.

In certain embodiments, transmission mode x as a new transmission mode that is defined for CoMP. Additionally, transmission mode x can be a new transmission mode that is defined for NCT or SCT.

In one example, transmission mode x is defined as in Table 2 below, wherein condition 1 can be based on:
whether there exists a higher layer configured parameter for configuring UE 116 behavior on the CSI feedback in transmission mode X;
whether there doesn't exist a higher layer configured parameter for configuring UE 116 behavior on the CSI feedback in transmission mode X;
a value of a higher-layer configured parameter for configuring UE 116 behavior on the CSI feedback in transmission mode X is a first value, where in one example the first value is true, and in another example the first value is false;
a parameter value implicitly derived from other higher layer parameters like CSI-RS or IMR configuration;
carrier type is a first carrier type, where in one example the first carrier type is legacy carrier;
carrier aggregation configuration;
the CSI reporting according to a periodic CSI configuration, wherein [Alt2] would apply and the condition 2 would be that the CSI reporting is according to an aperiodic CSI configuration;
the CSI reporting is according to an aperiodic CSI configuration, wherein [Alt 2] would apply and the condition 2 would be the CSI reporting is according to a periodic CSI configuration; and
PDSCH transmission scheme assumed for CSI reference resource.

TABLE 2

| | |
|---|---|
| X | If the UE is configured without PMI/RI |
| | reporting and condition 1: if the number |
| | of PBCH antenna ports is one, |
| | single-antenna port, port 0; otherwise |
| | transmit diversity |
| | If the UE is configured without PMI/RI |
| | reporting, [Alt 1] with complement of |
| | condition 1 [Alt 2] with condition 2: if the |
| | number of CSI-RS ports is one, |
| | single-antenna port, port 7; otherwise up |
| | to 8 layer transmission, ports 7-14 (see |
| | subclause 7.1.5B) |
| | If the UE is configured with PMI/RI |
| | reporting: if the number of CSI-RS ports |
| | is one, single-antenna port, port 7; |
| | otherwise up to 8 layer transmission, |
| | ports 7-14 (see subclause 7.1.5B) |

Note that with this approach, the network could reflect the beam-formed channel on CSI-RS. Such beamforming is possible based on uplink channel measurements or uplink reference symbols, such as SRSs. However, since such beam-formed CSI-RS is highly specific to UE 116, many more CSI-RSs need to be supported. To solve this issue, it may be preferable to support a new single port CSI-RS configuration without, e.g., code division multiplexing (CDM) of two ports, and with using time division multiplexing (TDM) of the same two adjacent REs to increase reuse.

Certain embodiments of the present disclosure support the use of RI with CQI. The rank for CQI report can be assumed to be same as the number of CSI-RS ports. Alternatively, the RI can be reported with a CQI to a network.

In this case, even if no PMI/RI reporting is configured, RI reporting can be enabled by separate configuration using, for example, an “RI reporting” parameter or similar. In another method, PMI reporting and RI reporting can be separately configured.

In certain embodiments, with RI reporting but no PMI reporting, if UE 116 reports N port CSI-RS, UE 116 computes CQI for rank 1 transmission using one of the CSI-RS ports (e.g., first port) and CQI for rank 2 transmission using two of the CSI-RS ports (e.g., first and second ports) and so forth, where a transmission scheme assumed is based on ports 7-14 of DMRS as described earlier.

Based on the CQI computation, UE 116 can be required to report rank as well. In one embodiment, UE 116 applies a power offset associated with a rank. Such power offset may be configurable by the network or implicitly determined by UE 116.

In an example with N=2 port CSI-RS, UE 116 determines CQI based on first CSI-RS port and with +3 dB offset. UE 116 also determines CQI based on first and second CSI-RS with 0 dB power offset. The reported rank and CQI are determined based on the two CQIs.

In another example, with N=2 port CSI-RS, UE 116 determines CQI based on first CSI-RS port and with x dB offset. UE 116 also determines CQI based on first and second CSI-RS with y dB power offset. Power offsets x and y can be configurable per rank or per CSI-RS configuration.

In certain embodiments, UE 116 calculates CQI using channel estimation or PRB bundling. Depending upon the implementation of single port CSI-RS, if CSI-RSs are beamformed, or equivalently PRB bundling is applied for CSI-RS, the channel can vary from PRB to PRB based on how precoding used by an eNB (e.g., BS 102) for a CSI-RS. This could affect channel estimation performance at UE 116. The network, via BS 102, can indicate this behavior to UE 116 to prevent certain receiver optimizations including averaging or filtering of CSI-RS over PRBs.

UE 116 can be informed by higher layer signaling whether the CSI-RS is beamformed. If CSI-RS is beamformed, UE 116 cannot assume the same precoding, i.e., continuous channel behavior, on adjacent PRBs.

In certain embodiments, UE 116 is informed by higher layer signaling that PRB bundling is used, i.e., the CSI-RS are beam-formed with same precoding over a number of PRBs. If CSI-RS is beamformed, UE 116 cannot assume the same precoding, i.e., continuous channel behavior, on adjacent sets of the number of PRBs. The number of PRBs over which precoding is bundled are configurable or fixed to a certain value. Alternatively, the number of PRBs that are bundled can be implicitly related to a feedback mode, such as a sub-band size in a configured feedback mode.

In certain embodiments, since beamforming of CSI-RS may vary in time, a network may explicitly configure via a certain parameter (e.g., a time bundling parameter) that UE 116 should not average channel measurements on CSI-RS in time for CSI computation.

In certain embodiments, a PMI is signaled to UE 116 by the network via BS 102 for CQI measurements if UE 116 is configured without PMI/RI reporting. A single wideband PMI can be configured by the network as part of radio resource control (RRC) signaling. More than one PMI can also be configured. The configuration can be part of a periodic CSI configuration.

Additionally or alternatively, a PMI can be indicated with control signaling. PMI can be included in the PDCCH or enhanced physical downlink control channel (ePDCCH) containing an aperiodic CSI request and UE 116 computes the CQI using the indicated PMI.

In certain embodiments, UE 116 computes CQI based on DMRS if configured without PMI/RI reporting, which is an alternative to the above where CQI computation at UE 116 was based on measurements using CRS or CSI-RS. Specifically, DMRS based channel estimates are used for CQI measurements. UE 116 requires a data allocation with DMRS to be able to measure CQI with DMRS based channel estimates.

UE 116 computes CQI based on DMRS if triggered by an aperiodic CSI request requesting DMRS based CQI. Alternatively, UE 116 can compute CQI using DMRS based on the most recent transmission to UE 116.

In certain embodiments, UE 116 computes CQI without PMI/RI reporting and can be based on a carrier type, such as an NCT carrier or an SCT carrier, with different bases for computing CQI based on the different carrier types.

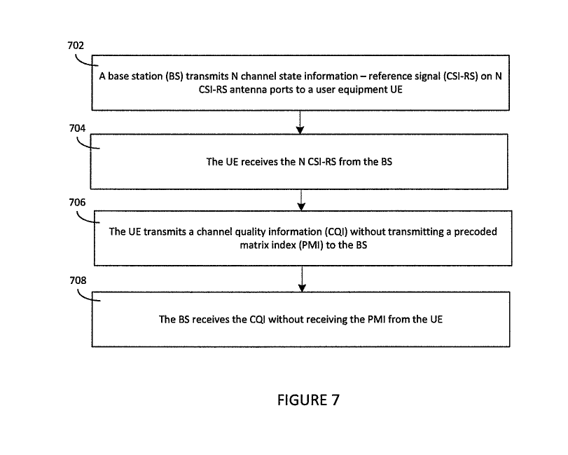

FIG. 7 illustrates a flow diagram for CQI transmission and reception in a multiple input multiple output (MIMO) communication system according to embodiments of the present disclosure. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented in, for example, one or more of a base station and a user equipment. BS 102 and UE 116 can each comprise one or more digital or analog processors configured to perform one or more steps depicted in the flow diagram of FIG. 7.

At 702, abase station, such as BS 102, transmits N channel state information-reference signal (CSI-RS) on N CSI-RS antenna ports to a UE, such as UE 116. BS 102 optionally transmits one or more configurations to UE 116 that configure one or more CSI-RSs and also configure how a channel quality indicator (CQI) is to be computed by UE 116. A precoding vector of a precoding matrix is optionally applied to the CSI-RS. The precoding vector is optionally aligned with an instantaneous channel vector between BS 102 and UE 116 that is obtained by uplink sounding relying on channel reciprocity. The instantaneous channel vector is optionally of an instantaneous channel matrix and the precoding matrix is optionally selected to at least partly utilize the instantaneous channel matrix. The CSI-RS is optionally beamformed with the precoding vector over a number of physical resource blocks (PRBs). If N is more than one, the CQI is calculated on demodulation reference signal (DMRS) antenna ports 7 to (7+N−1). The N CSI-RS antenna ports are mapped one to one to the DMRS antenna ports 7 to (7+N−1). Optionally, the UE assumes a rank of transmission is the same as N for a reference physical downlink shared channel (PDSCH) transmission scheme to calculate the CQI.

At 704, UE 116 receives the N CSI-RS from BS 102. UE 116 optionally receives one or more configurations from BS 102 that configure one or more CSI-RSs and also configure how CQI is to be computed by UE 116. Certain configurations may configure a transmission mode that supports coordinated multi-point (COMP) transmissions. Certain configurations may configure a channel quality information (CQI) feedback without a precoding matrix index (PMI) and without a rank indicator (RI). The CSI-RS is received via a CSI-RS port of a plurality of antenna ports of UE 116. If N is one, the CQI can be calculated on a single antenna port, antenna port 7. One or more channels on antenna port 7 are mapped from one or more channels on a CSI-RS port of the N CSI-RS antenna ports.

The CSI-RS port is optionally one of a plurality of CSI-RS ports of the plurality of antenna ports of UE 116. The plurality of CSI-RS ports are optionally mapped to a plurality of DMRS ports. Optionally, an antenna virtualization precoding matrix is applied to the CSI-RS on the multiple antenna ports, where each antenna port carries a CSI-RS precoded with each column vector of a precoding matrix. Each column vector of the precoding matrix can be substantially aligned with an instantaneous channel vector associated with each antenna port that is obtained by uplink sounding. UE 116 is optionally informed by higher layer signaling whether or not PRB bundling is applied for CSI-RS. If the PRB bundling is applied, each of the CSI-RS is precoded with a substantially similar precoding vector within a fixed number of physical resource blocks (PRBs).

At 706, UE 116 transmits channel quality information (CQI) without transmitting a precoded matrix index to BS 102. The CQI is based on a CSI-RS port of a plurality of antenna ports of UE 116. UE 116 optionally transmits a rank indication (RI) associated with the CQI to BS 102. The CQI is optionally one of a plurality of CQIs for each of the plurality of CSI-RS ports. UE 116 optionally applies a power offset to the CSI-RS port based on a rank associated with the RI. UE 116 optionally does not use a receiver optimization on the CSI-RS over a plurality of PRBs that includes the number of PRBs to compute the CQI. The receiver optimization includes one or more of averaging and filtering.

At 708, BS 102 receives the CQI without receiving the PMI from UE 116. BS 102 may optionally receive the RI associated with the CQI from UE 116. BS 102 may update a modulation coding scheme (MCS) based on the CQI.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of operating a base station (BS) communicating with a user equipment (UE), the method comprising:
transmitting N channel state information reference signal (CSI-RS) on N CSI-RS antenna ports to the UE;
wherein a transmission mode is configured that supports coordinated multi-point (COMP) transmissions;
wherein a channel quality information (CQI) feedback configuration requires CQI feedback without a precoding matrix index (PMI) and without a rank indicator (RI); and
receiving a CQI from the UE according to the CQI feedback configuration;
wherein if N is one, the CQI is calculated on a single antenna port, antenna port 7, and the single antenna port is mapped from the N equals one CSI-RS antenna port.

2. The method of claim 1,
wherein an antenna virtualization precoding matrix is applied to the CSI-RS on the multiple antenna ports, where each antenna port carries a CSI-RS precoded with each column vector of a precoding matrix; and
wherein each column vector of the precoding matrix is substantially aligned with an instantaneous channel vector associated with each antenna port that is obtained by uplink sounding.

3. The method of claim 1,
wherein the UE is informed by higher layer signaling whether or not PRB bundling is applied for CSI-RS; and
wherein if the PRB bundling is applied, each of the CSI-RS is precoded with a substantially similar precoding vector within a fixed number of physical resource blocks (PRBs).

4. The method of claim 1,
wherein if N is more than one, the CQI is calculated on demodulation reference signal (DMRS) antenna ports 7 to (7+N−1); and
wherein the N CSI-RS antenna ports are mapped one to one to the DMRS antenna ports 7 to (7+N−1).

5. The method of claim 4,
wherein the UE assumes a rank of transmission is the same as N for a reference physical downlink shared channel (PDSCH) transmission scheme to calculate the CQI.

6. Abase station (BS) configured to communicate with a user equipment (UE), the BS comprising:
a transmit path configured to transmit N channel state information reference signal (CSI-RS) on N CSI-RS antenna ports to the UE;
wherein a transmission mode is configured that supports coordinated multi-point (COMP) transmissions;
wherein a channel quality information (CQI) feedback configuration requires CQI feedback without a precoding matrix index (PMI) and without a rank indicator (RI); and
processing circuitry configured to:
receive a CQI from the UE according to the CQI feedback configuration,
wherein if N is one, the CQI is calculated on a single antenna port, antenna port 7, and the single antenna port is mapped from the N equals one CSI-RS antenna port.

7. The BS of claim 6,
wherein an antenna virtualization precoding matrix is applied to the CSI-RS on the multiple antenna ports, where each antenna port carries a CSI-RS precoded with each column vector of a precoding matrix; and
wherein each column vector of the precoding matrix is substantially aligned with an instantaneous channel vector associated with each antenna port that is obtained by uplink sounding.

8. The BS of claim 6,
wherein the UE is informed by higher layer signaling whether or not PRB bundling is applied for CSI-RS; and
wherein if the PRB bundling is applied, each of the CSI-RS is precoded with a substantially similar precoding vector within a fixed number of physical resource blocks (PREs).

9. The BS of claim 6,
wherein if N is more than one, the CQI is calculated on demodulation reference signal (DMRS) antenna ports 7 to (7+N−1); and
wherein the N CSI-RS antenna ports are mapped one to one to the DMRS antenna ports 7 to (7+N−1).

10. The BS of claim 9,
wherein the UE assumes a rank of transmission is the same as N for a reference physical downlink shared channel (PDSCH) transmission scheme to calculate the CQI.

11. A method of operating a user equipment (UE) communicating with a base station (BS), the method comprising:
receiving N channel state information reference signal (CSI-RS) on N CSI-RS antenna ports from the BS;
wherein a transmission mode is configured that supports coordinated multi-point (COMP) transmissions;
wherein a channel quality information (CQI) feedback configuration requires CQI feedback without a precoding matrix index (PMI) and without a rank indicator (RI); and
transmitting a CQI to the BS according to the CQI feedback configuration;
wherein if N is one, the CQI is calculated on a single antenna port, antenna port 7, and the single antenna port is mapped from the N equals one CSI-RS antenna port.

12. The method of claim 11,
wherein an antenna virtualization precoding matrix is applied to the CSI-RS on the multiple antenna ports, where each antenna port carries a CSI-RS precoded with each column vector of a precoding matrix; and
wherein each column vector of the precoding matrix is substantially aligned with an instantaneous channel vector associated with each antenna port that is obtained by uplink sounding.

13. The method of claim 11,
wherein the UE is informed by higher layer signaling whether or not PRB bundling is applied for CSI-RS; and
wherein if the PRB bundling is applied, each of the CSI-RS is precoded with a substantially similar precoding vector within a fixed number of physical resource blocks (PRBs).

14. The method of claim 11,
wherein if N is more than one, the CQI is calculated on demodulation reference signal (DMRS) antenna ports 7 to (7+N−1); and
wherein the N CSI-RS antenna ports are mapped one to one to the DMRS antenna ports 7 to (7+N−1).

15. The method of claim 14,
wherein the UE assumes a rank of transmission is the same as N for a reference physical downlink shared channel (PDSCH) transmission scheme to calculate the CQI.

16. A user equipment (UE) configured to communicate with a base station (BS), the UE comprising:
a transceiver configured to receive N channel state information reference signal (CSI-RS) on N CSI-RS antenna ports from the BS, wherein a transmission mode is configured that supports coordinated multi-point (COMP) transmissions, wherein a channel quality information (CQI) feedback configuration requires CQI feedback without a precoding matrix index (PMI) and without a rank indicator (RI); and
processing circuitry configured to transmit, via the transceiver, a CQI to the BS according to the CQI feedback configuration, wherein if N is one, the CQI is calculated on a single antenna port, antenna port 7, and the single antenna port is mapped from the N equals one CSI-RS antenna port.

17. The UE of claim 16,
wherein an antenna virtualization precoding matrix is applied to the CSI-RS on the multiple antenna ports, where each antenna port carries a CSI-RS precoded with each column vector of a precoding matrix; and
wherein each column vector of the precoding matrix is substantially aligned with an instantaneous channel vector associated with each antenna port that is obtained by uplink sounding.

18. The UE of claim 16,
wherein the UE is informed by higher layer signaling whether or not PRB bundling is applied for CSI-RS; and
wherein if the PRB bundling is applied, each of the CSI-RS is precoded with a substantially similar precoding vector within a fixed number of physical resource blocks (PRBs).

19. The UE of claim 16,
wherein if N is more than one, the CQI is calculated on demodulation reference signal (DMRS) antenna ports 7 to (7+N−1); and
wherein the N CSI-RS antenna ports are mapped one to one to the DMRS antenna ports 7 to (7+N−1).

20. The UE of claim 19,
wherein the UE assumes a rank of transmission is the same as N for a reference physical downlink shared channel (PDSCH) transmission scheme to calculate the CQI.
